(19) United States
(12) Patent Application Publication
(10) Pub. No.: US 2020/0365861 A1
(43) Pub. Date: Nov. 19, 2020

(54) APPLICATION OF LIGNOSULFONATES AND HIGH SURFACE AREA CARBON ON BATTERY SEPARATOR COMPONENT FOR HIGH CHARGE ACCEPTANCE IN ENHANCED FLOODED AND VRLA AGM BATTERIES

(71) Applicant: MICROPOROUS, LLC, Piney Flats, TN (US)

(72) Inventors: Divya TIWARI, Johnson City, TN (US); David MIHARA, Johnson City, TN (US)

(21) Appl. No.: 16/874,484

(22) Filed: May 14, 2020

Related U.S. Application Data
(60) Provisional application No. 62/847,517, filed on May 14, 2019.

(51) Int. Cl. H01M 2/14; H01M 2/16; H01M 10/06; C03C 25/1095; C03C 25/47; C03C 25/44; C03C 25/25

(52) U.S. Cl. CPC H01M 2/145; H01M 2/1613; H01M 2/166; H01M 10/06; H01M 2220/20; C03C 25/47; C03C 25/44; C03C 25/25; C03C 25/1095

(57) ABSTRACT

A method of battery separator manufacture and method of use includes applying a slurry including high surface area carbon to a glass mat scrim on a negative separator. A method for the application of a slurry including the high surface area carbon to a glass mat scrim on the negative separator to increase charge acceptance and/or cycle life of a lead acid battery. A battery separator with a glass mat scrim having a slurry including high surface area carbon for increasing charge acceptance and/or cycle life of a lead acid battery. The method or battery separator wherein the slurry including the high surface area carbon, lignosulfonate, and a binder. The method or battery separator disclosed herein being used in a flooded or an enhanced flooded battery “EFB”. The method or battery separator disclosed herein being used in an absorbed glass mat “AGM” battery.

### CROSS-REFERENCE TO RELATED APPLICATIONS

This application claims the priority benefit of U.S. Provisional Application No. 62/847,517, filed on May 14, 2019, entitled “Application of Lignosulfonates and High Surface Area Carbon on Battery Separator Component for High Charge Acceptance in Enhanced Flooded and VRLA AGM Batteries”, which is incorporated by reference herein in its entirety.

### FIELD OF THE DISCLOSURE

The present disclosure relates generally to lead acid batteries, and particularly to new and improved separators containing a glass mat coated with high surface area carbon and lignosulfonate additives to enhance charge acceptance and cycle life of enhanced flooded lead acid batteries. The present disclosure is directed to new or improved battery separators, and/or related methods of production and/or use thereof, including such additives for use with a battery separator for use in a lead acid battery.

### BACKGROUND

Lead acid batteries have been popular, low cost rechargeable energy storage devices for more than a century. Despite low energy-to-volume ratio, it can provide high surge currents, which make it attractive for starter motors, automotive, forklifts, Uninterruptible Power Supply, etc. The two main types of lead acid batteries are flooded batteries and valve regulated lead acid (VRLA) batteries. An “enhanced” flooded battery is an improved and more robust flooded lead acid battery for use in automobiles using “Idle-Start-Stop” technology. In this technology, the battery must provide power to maintain the car's electrical system when the alternator stops generating current. Other features of this technology include regenerative breaking and opportunity charging. Due to such demands, the technology needs a battery with fast charging and enhanced cycling capability.

At present, “Start-Stop” vehicles use AGM (Absorbed Glass Mat) and EFB (Enhanced Flooded Battery), both supporting increased cycle life and fast charging capability. The current disclosure may be useful to both AGM and enhanced flooded battery and battery systems with need for enhanced cycle life and high charge acceptance, especially in High Rate Partial State of Charge (HRPSoC) applications.

The present disclosure may be designed to provide an added component to the existing AGM or flooded battery separator. The battery separator separates or divides the positive electrode from the negative electrode within a lead acid battery cell. The separator permits exchange of ions with least possible resistance, while preventing a short that will result from the positive and negative electrode touching each other. Flooded battery separators may be made from a porous matrix and may incorporate inorganic fillers such as Silica, Alumina, Zirconia, Mineral clays or others known to those skilled in the art. The flooded battery separator may also incorporate specific additives such as water loss mitigating substances, antioxidant substances and rubber latexes among other materials offering specifically desirable activity. The bulk of the separator may be comprised of crosslinked natural and/or synthetic rubber, organic polymers of varying molecular weight such as polyesters, polysulfones and polyolefins (typically of molecular weight between 300K and 12MM). Other materials used to manufacture flooded battery separators include wet-laid and dry-laid nonwovens typically produced from polyester and/or glass fiber. In certain cases the nonwoven separator is coated with phenolic compounds to enhance oxidation resistance. Many such separators possess a laminate comprised of glass or polyester in the form of a scrim with an open pore structure attached to the side of the separator facing the positive plate. The laminate or scrim prevents the oxidation of the rubber or polymer from the oxidative potential of the positive electrode, thereby increasing the life of the separator.

An AGM battery separator may typically be made from a nonwoven mat with coarse and fine glass fibers. The same AGM separator may also contain polymer additives to improve tensile strength and puncture resistance for easy processing during battery manufacturing and service life. In AGM batteries, the electrolyte is immobilized between or in the absorptive glass mat. It also allows for transport of oxygen to the negative plate for recombination, thereby reducing the water loss. The AGM separator may be any glass mat, pasting paper, or the like. Examples of an AGM separator may be, but are not limited to, having a specific surface area of 0.4-2.2 m2/g. A laminate or scrim with coarse glass fibers and/or polyester or other polymer blend may also be attached to the AGM separator.

However, with lead acid battery technology, and especially enhanced flooded lead acid battery technologies and AGM battery technologies, there is always a need or desire for improvement. With growing energy demands of energy storage batteries and enhanced flooded batteries of start stop vehicles, there is a need for continued improvement of lead acid battery technology. The instant disclosure recognizes the need to provide lead acid batteries, and especially enhanced flooded lead acid batteries and AGM batteries with higher charge acceptance and/or cycle life.

Charge acceptance enhancement in lead acid batteries has been an important focus for research in the last several decades. Carbons such as carbon black, advanced graphites, multi walled nanocarbons, high surface area carbons have been incorporated in lead acid batteries in many forms. Exide incorporates advanced graphites in NAM (Negative Active Material) as per U.S. Pat. No. 8,765,297. Daramic applies carbon coating on the separator surface and East Penn Manufacturing uses sprayed carbon on negative electrode surface (see J. Furukawa, K. Smith, L. T. Lam, D. A. J. Rand, Towards sustainable road transport with the UltraBattery™, in J. Garche, E. Karden, P. T. Moseley, D. A. J. Rand (Eds.); and Lead-Acid Batteries for Future Automobiles, Elsevier, Amsterdam, The Netherlands, 2017, pp. 349-391. ISBN: 978-0-444-63700-0).

The present disclosure may be designed to address at least certain aspects of the problems or needs discussed above by providing new and/or improved battery separators with a glass mat coated with high surface area carbon and lignosulfonate additives to enhance charge acceptance and/or cycle life of enhanced flooded lead acid batteries and absorbed glass mat batteries. As such, the present disclosure may generally be designed to provide a coating treatment with a blend of carbon and lignosulfonate on any laminate structure, like a polyester or glass nonwoven or scrim, which may be attached to the AGM or flooded battery separator. The coated polyester or glass nonwoven mat/scrim may also be attached to an EFB or flooded battery separator, the laminate or scrim component facing the negative plate.

### SUMMARY

The present disclosure may solve the aforementioned limitations of the currently available battery separator technologies by providing an application of lignosulfonates and high surface area carbon on battery separator component for high charge acceptance in enhanced flooded and VRLA AGM batteries. Accordingly, in one aspect the instant disclosure embraces a method of manufacturing a battery separator to increase charge acceptance, cycle life or a combination thereof of a lead-acid battery with a glass mat scrim on a negative separator. This disclosed method generally includes the step of coating the glass mat scrim on the negative separator with a slurry including a high surface area carbon and a lignosulfonate.

One feature of the disclosed method of manufacturing a battery separator to increase charge acceptance, cycle life or a combination thereof of a lead-acid battery with a glass mat scrim on a negative separator, the step of coating of the glass mat scrim on the negative separator with the slurry may be configured to increase charge acceptance, cycle life, or combinations thereof of the lead acid battery.

In select embodiments of the disclosed method of manufacturing a battery separator to increase charge acceptance, cycle life or a combination thereof of a lead-acid battery with a glass mat scrim on a negative separator, the lead-acid battery may be an enhanced flooded battery (EFB).

In other select embodiments of the disclosed method of manufacturing a battery separator to increase charge acceptance, cycle life or a combination thereof of a lead-acid battery with a glass mat scrim on a negative separator, the lead-acid battery may be an absorbed glass mat (AGM) battery.

In select embodiments, the disclosed method of manufacturing a battery separator to increase charge acceptance, cycle life or a combination thereof of a lead-acid battery with a glass mat scrim on a negative separator may further include the steps of: air drying the coated glass mat scrim; and placing the glass mat scrim with the applied slurry on a negative separator leaf or an envelope such that the glass mat scrim with the applied slurry faces the surface of a negative electrode in a cell assembly.

In select embodiments of the disclosed method of manufacturing a battery separator to increase charge acceptance, cycle life or a combination thereof of a lead-acid battery with a glass mat scrim on a negative separator, the slurry coated to the glass mat scrim on the negative separator may include the high surface area carbon, the lignosulfonate, and a binder.

The high surface area carbon used in the slurry coated to the glass mat scrim on the negative separator may have a specific surface area between 15-1800 m2/g. In select possibly preferred embodiments, the specific surface area of the high surface area carbon may be between 1300-1500 m2/g. In select embodiments, the high surface area carbon may be between 10%-40% by dry weight of the slurry. In select possibly preferred embodiments, the high surface area carbon may be 30%-40% by dry weight of the slurry. As an example, and clearly not limited thereto, in select possibly preferred embodiments, the high surface area carbon may be PBX51. In select embodiments, the high surface area carbon may be configured to have a capacitive effect due to its large surface are in close proximity to the current collector grid or negative active material. In other select embodiments, the high surface area carbon may pose a steric hindrance in growth of large lead sulfate crystals and may ensure the efficient recharge of lead sulfate back into lead, thereby preventing sulfation of the negative electrodes and increasing the life of the lead-acid battery. In other select embodiments, the high surface area carbon may be configured to help in electrode irrigation by providing acid reservoir when used in negative active material. In yet other select embodiments, the high surface area carbon may be configured to have a beneficial effect as an acid reservoir, even when used in close contact with the surface of the negative electrode. In other select embodiments, the high surface area carbon may be configured as a combination of the embodiments shown and/or discussed herein.

The lignosulfonate used in the slurry coated to the glass mat scrim on the negative separator may be hydrophilic and water soluble compared to hydrophobic carbon additives. Wherein the lignosulfonates may aid in mixing and preparation of the slurry. In select embodiments, the lignosulfonates in the slurry may be configured to prevent the formation of large PbSO4 crystals during discharge state with strong antiflocculent properties which may prevent affective recharge and consequent conversion of PbSO4 into Pb. In select other embodiments, the lignosulfonates may preserve a spongy lead structure on the negative electrode in the recharge state. In select possibly preferred embodiments, but clearly not limited thereto, the lignosulfonates may be Vanisperse A.

The binder used in the slurry coated to the glass mat scrim on the negative separator may be a mixing aid. In select embodiments, the binder may be a surfactant that helps reduce the surface energy of the slurry and aids in the effective mixing and preparing a homogeneous slurry for coating of the glass mat or scrim. As examples, and clearly not limited thereto, in select embodiments, the binder may be MA80, Guar Gum, Gum Arabic, Carboxymethylcellulose, fumed silica, PEG, the like, or combinations thereof. In a possibly preferred embodiment, the binder may be MA80.

In select embodiments of the disclosed method of manufacturing a battery separator to increase charge acceptance, cycle life or a combination thereof of a lead-acid battery with a glass mat scrim on a negative separator, the slurry coated to the glass mat scrim on the negative separator may further include a solvent. The solvent may be configured for mixing the slurry. Wherein, in select embodiments, the solvent does not include ionized water.

One feature of the disclosed method of manufacturing a battery separator to increase charge acceptance, cycle life or a combination thereof of a lead-acid battery with a glass mat scrim on a negative separator may be that the charge acceptance of the lead-acid battery may be increased at least 2 times compared to that of a standard cell with no carbon coated glass mat in the separator of a lead acid battery 2V cell tested under DCA conditions. In select embodiments, the charge acceptance of the lead-acid battery may be increased between 2 and 3 times compared to that of a standard cell with no carbon coated glass mat in the separator of a lead acid battery 2V cell tested under DCA conditions. In select possibly preferred embodiments, the charge acceptance of the lead-acid battery may be increased by approximately 3 times compared to that of a standard cell with no carbon coated glass mat in the separator of a lead acid battery 2V cell tested under DCA conditions

Another feature of the disclosed method of manufacturing a battery separator to increase charge acceptance, cycle life or a combination thereof of a lead-acid battery with a glass mat scrim on a negative separator may be that the slurry applied on the glass mat or scrim may provide acid stratification mitigation benefits from the carbon, the glass mat, or a combination of both.

In another aspect, the instant disclosure embraces a battery separator for a lead-acid battery. The battery separator may include a glass mat scrim. The battery separator may be positioned on a negative separator. The battery separator may include a slurry coated on the glass mat scrim on the negative separator. The slurry may generally include a high surface area carbon and a lignosulfonate.

One feature of the disclosed battery separator may be that the slurry coated on the glass mat scrim on the negative separator may be configured to increase charge acceptance, cycle life, or combinations thereof of the lead acid battery.

In select embodiments of the disclosed battery separator, the lead-acid battery may be a flooded or an enhanced flooded battery (EFB).

In other select embodiments of the disclosed battery separator, the lead-acid battery may be an absorbed glass mat (AGM) battery.

In select embodiments of the disclosed battery separator to increase charge acceptance, cycle life or a combination thereof of a lead-acid battery with a glass mat scrim on a negative separator, the slurry coated to the glass mat scrim on the negative separator may include the high surface area carbon, the lignosulfonate, and a binder.

The high surface area carbon used in the slurry coated to the glass mat scrim on the negative separator may have a specific surface area between 15-1800 m2/g. In select possibly preferred embodiments, the specific surface area of the high surface area carbon may be between 1300-1500 m2/g. In select embodiments, the high surface area carbon may be between 10%-40% by dry weight of the slurry. In select possibly preferred embodiments, the high surface area carbon may be 30%-40% by dry weight of the slurry. As an example, and clearly not limited thereto, in select possibly preferred embodiments, the high surface area carbon may be PBX51. In select embodiments, the high surface area carbon may be configured to have a capacitive effect due to its large surface are in close proximity to the current collector grid or negative active material. In other select embodiments, the high surface area carbon may pose a steric hindrance in growth of large lead sulfate crystals and may ensure the efficient recharge of lead sulfate back into lead, thereby preventing sulfation of the negative electrodes and increasing the life of the lead-acid battery. In other select embodiments, the high surface area carbon may be configured to help in electrode irrigation by providing acid reservoir when used in negative active material. In yet other select embodiments, the high surface area carbon may be configured to have a beneficial effect as an acid reservoir, even when used in close contact with the surface of the negative electrode. In other select embodiments, the high surface area carbon may be configured as a combination of the embodiments shown and/or discussed herein.

The lignosulfonate used in the slurry coated to the glass mat scrim on the negative separator may be hydrophilic and water soluble compared to hydrophobic carbon additives. Wherein the lignosulfonates may aid in mixing and preparation of the slurry. In select embodiments, the lignosulfonates in the slurry may be configured to prevent the formation of large PbSO4 crystals during discharge state with strong antiflocculent properties which may prevent affective recharge and consequent conversion of PbSO4 into Pb. In select other embodiments, the lignosulfonates may preserve a spongy lead structure on the negative electrode in the recharge state. In select possibly preferred embodiments, but clearly not limited thereto, the lignosulfonates may be Vanisperse A.

The binder used in the slurry coated to the glass mat scrim on the negative separator may be a mixing aid. In select embodiments, the binder may be a surfactant that helps reduce the surface energy of the slurry and aids in the effective mixing and preparing a homogeneous slurry for coating of the glass mat or scrim. As examples, and clearly not limited thereto, in select embodiments, the binder may be MA80, Guar Gum, Gum Arabic, Carboxymethylcellulose, fumed silica, PEG, the like, or combinations thereof. In a possibly preferred embodiment, the binder may be MA80.

In select embodiments of the disclosed battery separator, the slurry coated to the glass mat scrim on the negative separator may further include a solvent. The solvent may be configured for mixing the slurry. Wherein, in select embodiments, the solvent does not include ionized water.

One feature of the disclosed battery separator may be that the charge acceptance of the lead-acid battery may be increased at least 2 times compared to that of a standard cell with no carbon coated glass mat in the separator of a lead acid battery 2V cell tested under DCA conditions. In select embodiments, the charge acceptance of the lead-acid battery may be increased between 2 and 3 times compared to that of a standard cell with no carbon coated glass mat in the separator of a lead acid battery 2V cell tested under DCA conditions. In select possibly preferred embodiments, the charge acceptance of the lead-acid battery may be increased by approximately 3 times compared to that of a standard cell with no carbon coated glass mat in the separator of a lead acid battery 2V cell tested under DCA conditions

Another feature of the disclosed battery separator may be that the slurry applied on the glass mat or scrim may provide acid stratification mitigation benefits from the carbon, the glass mat, or a combination of both.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

The present disclosure will be better understood by reading the Detailed Description with reference to the accompanying drawings, which are not necessarily drawn to scale, and in which like reference numerals denote similar structure and refer to like elements throughout, and in which:

FIG. 1 illustrates a lead-acid battery with a cut away portion showing the internal components of the lead-acid battery for utilizing the additive according to select embodiments of the instant disclosure;

FIG. 2A shows a bi-layer roll of flooded or EFB battery separator with major ribs on the top (positive plate side of the separator) and a carbon-lignosulfonate coated glass mat or scrim, according to select embodiments of the instant disclosure, affixed to the mini-rib or flat sheet side on the bottom (negative plate side of the separator);

FIG. 2B shows a cross-section of the battery separator from FIG. 2A with the top layer separator (flooded or EFB battery separator) and a bottom layer of glass mat/laminate/scrim/pasting paper coated with carbon-lignosulfonate-binder on mini rib side according to select embodiments of the instant disclosure;

FIG. 2C shows a zoomed-in detailed view of the cross-section of the battery separator from FIG. 2B;

FIG. 3 shows a side view of a bi-layer roll of flooded or EFB battery separator and a carbon-lignosulfonate-binder coated glass mat/laminate/scrim according to select embodiments of the instant disclosure; and

FIG. 4 shows a flow chart of the method of manufacturing a battery separator to increase charge acceptance, cycle life or a combination thereof of a lead-acid battery with a glass mat scrim on a negative separator according to select embodiments of the instant disclosure.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

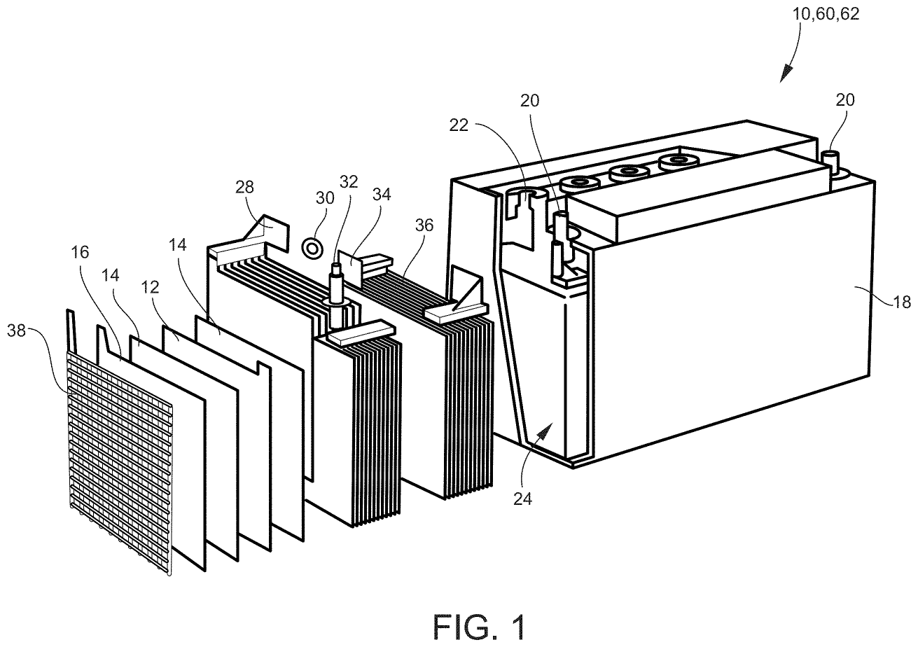

Referring now to FIGS. 1-4, in describing the exemplary embodiments of the present disclosure, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples and are merely examples among other possible examples.

Referring now to FIG. 1, in a possibly preferred embodiment, the present disclosure overcomes the above-mentioned disadvantages and meets the recognized need for such an apparatus or method by providing of lead-acid battery 10. Lead-acid battery 10 may be any size or type of lead-acid battery, including, but not limited to, a flooded or an enhanced flooded battery (“EFB”) 60, as shown in FIG. 1. In addition, lead-acid battery 10 may also be a absorbent glass mat (“AGM”) battery 62, like a valve regulated lead acid (VRLA) battery with absorbent glass mat 15. As shown, battery 10 includes negative plate (electrode) 12 and positive plate (electrode) 16 with separator 14 sandwiched therebetween. These components are housed within container, case or housing 18 that also includes terminal posts 20, valve adapter and valve 22, and electrolyte 24. A positive plate pack is shown with positive cell connection 28 and a negative pole 32. A negative plate pack 36 is shown with a negative cell connection 34. An electrolyte tight sealing ring 30 is shown for sealing electrolyte 24. Also shown is grid plate 38. Although a particular battery is shown, the inventive additive may be used in many different types of batteries or devices including for example, but not limited to, sealed lead-acid, flooded lead-acid, ISS lead-acid, combined battery and capacitor units, other battery types, capacitors, accumulators, and/or the like.

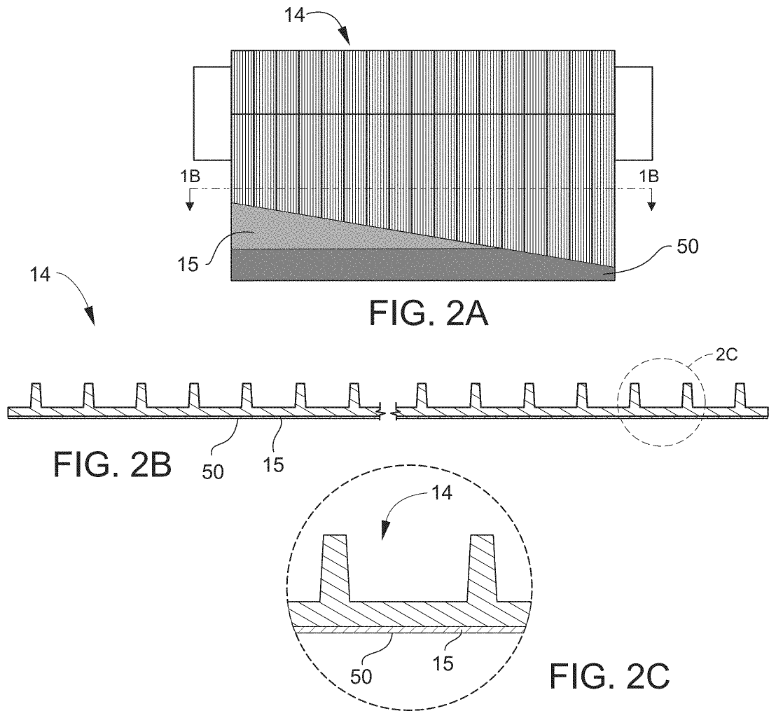

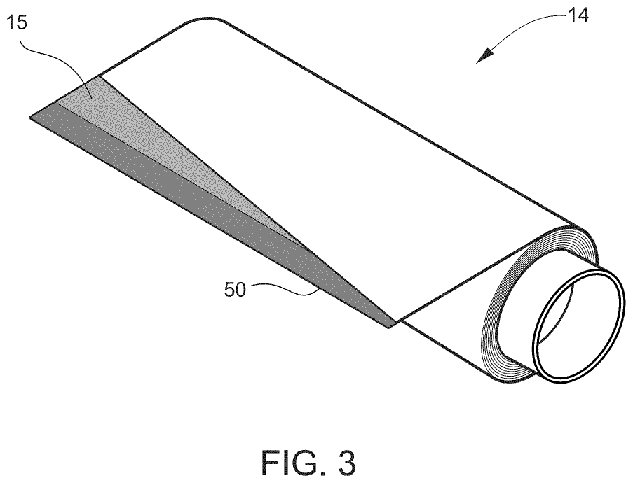

Referring now to FIGS. 2-3, the present disclosure solves the aforementioned limitations of the currently available battery separator technologies by providing battery separator 14 for lead-acid battery 10. Battery separator 14 may include glass mat scrim 15. Battery separator 14 may be positioned as a negative separator in lead-acid battery 10. Battery separator 14 may include slurry 50 coated on glass mat scrim 15 on the negative separator. Slurry 50 may generally include high surface area carbon 52 and lignosulfonate 54. Slurry 50 coated on glass mat scrim 15 on the negative separator may be configured to increase charge acceptance, cycle life, or combinations thereof of lead acid battery 10. In select embodiments of battery separator 14, lead-acid battery 10 may be a flooded or an enhanced flooded battery (EFB) 60. In other select embodiments of battery separator 14, lead-acid battery 10 may be an absorbed glass mat (AGM) battery 62. Slurry 50 coated to the glass mat scrim 15 on the negative separator may include high surface area carbon 52, lignosulfonate 54, and binder 56.

High surface area carbon 52 used in slurry 50 coated to glass mat scrim 15 on the negative separator 14 may have a specific surface area between 15-1800 m2/g. In select possibly preferred embodiments, the specific surface area of high surface area carbon 52 may be between 1300-1500 m2/g. In select embodiments, high surface area carbon 52 may be between 10%-40% by dry weight of slurry 50. In select possibly preferred embodiments, high surface area carbon 52 may be 30%-40% by dry weight of slurry 50. As an example, and clearly not limited thereto, in select possibly preferred embodiments, high surface area carbon 52 may be PBX51. In select embodiments, high surface area carbon 52 may be configured to have a capacitive effect due to its large surface are in close proximity to the current collector grid 38 or negative active material. In other select embodiments, high surface area carbon 52 may pose a steric hindrance in growth of large lead sulfate crystals and may ensure the efficient recharge of lead sulfate back into lead, thereby preventing sulfation of the negative electrodes and increasing the life of lead-acid battery 10. In other select embodiments, high surface area carbon 52 may be configured to help in electrode irrigation by providing acid reservoir when used in negative active material. In yet other select embodiments, high surface area carbon 52 may be configured to have a beneficial effect as an acid reservoir, even when used in close contact with the surface of the negative electrode. In other select embodiments, high surface area carbon 52 may be configured as a combination of the embodiments shown and/or discussed herein.

Lignosulfonate 54 used in slurry 50 coated to the glass mat scrim 15 on the negative separator 14 may be hydrophilic and water soluble compared to hydrophobic carbon additives. Wherein lignosulfonates 54 may aid in mixing and preparation of slurry 50. In select embodiments, lignosulfonates 54 in slurry 50 may be configured to prevent the formation of large PbSO4 crystals during discharge state with strong antiflocculent properties which may prevent affective recharge and consequent conversion of PbSO4 into Pb. In select other embodiments, lignosulfonates 54 may preserve a spongy lead structure on the negative electrode in the recharge state. In select possibly preferred embodiments, but clearly not limited thereto, lignosulfonates 54 may be Vanisperse A.

Binder 56 used in slurry 50 coated to the glass mat scrim 15 on the negative separator 14 may be a mixing aid. In select embodiments, binder 56 may be a surfactant that helps reduce the surface energy of slurry 50 and aids in the effective mixing and preparing a homogeneous slurry for coating of the glass mat or scrim 15. As examples, and clearly not limited thereto, in select embodiments, binder 56 may be MA80, Guar Gum, Gum Arabic, Carboxymethylcellulose, fumed silica, PEG, the like, or combinations thereof. In a possibly preferred embodiment, binder 56 may be MA80.

In select embodiments of battery separator 14, slurry 50 coated to the glass mat scrim 15 on the negative separator 14 may further include solvent 58. Solvent 58 may be configured for mixing slurry 50. Wherein, in select embodiments, solvent 58 does not include ionized water.

One feature of battery separator 14 with slurry 50 coated to glass mat scrim 15 may be that the charge acceptance of lead-acid battery 10 may be increased at least 2 times compared to that of a standard cell with no carbon coated glass mat in the separator of a lead acid battery 2V cell tested under DCA conditions. In select embodiments, the charge acceptance of lead-acid battery 10 with separator 14 with slurry 50 coated to glass mat scrim 15 may be increased between 2 and 3 times compared to that of a standard cell with no carbon coated glass mat in the separator of a lead acid battery 2V cell tested under DCA conditions. In select possibly preferred embodiments, the charge acceptance of lead-acid battery 10 with separator 14 with slurry 50 coated to glass mat scrim 15 may be increased by approximately 3 times compared to that of a standard cell with no carbon coated glass mat in the separator of a lead acid battery 2V cell tested under DCA conditions

Another feature of battery separator 14 may be that slurry 50 applied on glass mat or scrim 15 may provide acid stratification mitigation benefits from carbon 52, glass mat 15, or a combination of both.

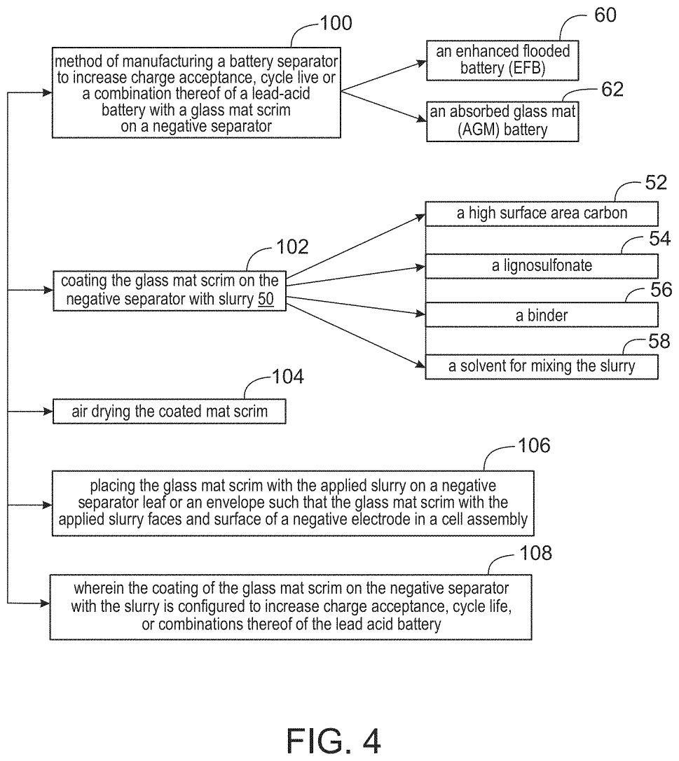

Referring now to FIG. 4, in one aspect the instant disclosure embraces method 100 of manufacturing battery separator 14 to increase charge acceptance, cycle life or a combination thereof of lead-acid battery 10 with glass mat scrim 15 on negative separator 14. Method 100 generally includes step 102 of coating glass mat scrim 15 on negative separator 14 with slurry 50, where slurry 50 generally includes high surface area carbon 52 and lignosulfonate 54. Step 102 of method 100 of coating of glass mat scrim 15 on negative separator 14 with slurry 50 may be configured to increase charge acceptance, cycle life, or combinations thereof of lead acid battery 10. In select embodiments of method 100, lead-acid battery 10 may be flooded or enhanced flooded battery (EFB) 60. In other select embodiments of method 100, lead-acid battery 10 may be absorbed glass mat (AGM) battery 62.

In select embodiments, method 100 of manufacturing battery separator 14 to increase charge acceptance, cycle life or a combination thereof of lead-acid battery 10 with glass mat scrim 15 on negative separator 14 may further include the steps of: step 104 of air drying coated glass mat scrim 15; and placing glass mat scrim 15 with applied slurry 50 on a negative separator leaf or an envelope such that the glass mat scrim 15 with the applied slurry 50 faces the surface of a negative electrode in a cell assembly.

Method 100 of manufacturing battery separator 14 to increase charge acceptance, cycle life or a combination thereof of lead-acid battery 10 with glass mat scrim 15 on negative separator 14 may include coating slurry 50 to glass mat scrim 15 in any of the various embodiments and/or combination of embodiments shown and/or described herein of slurry 50.

One feature of method 100 of manufacturing battery separator 14 to increase charge acceptance, cycle life or a combination thereof of lead-acid battery 10 with glass mat scrim 15 on negative separator 14, may be that the charge acceptance of lead-acid battery 10 may be increased at least 2 times compared to that of a standard cell with no carbon coated glass mat in the separator of a lead acid battery 2V cell tested under DCA conditions. In select embodiments of method 100, the charge acceptance of lead-acid battery 10 may be increased between 2 and 3 times compared to that of a standard cell with no carbon coated glass mat in the separator of a lead acid battery 2V cell tested under DCA conditions. In select possibly preferred embodiments of method 100, the charge acceptance of the lead-acid battery may be increased by approximately 3 times compared to that of a standard cell with no carbon coated glass mat in the separator of a lead acid battery 2V cell tested under DCA conditions

Another feature of method 100 of manufacturing battery separator 14 to increase charge acceptance, cycle life or a combination thereof of lead-acid battery 10 with glass mat scrim 15 on negative separator 14, may be that it can provide acid stratification mitigation benefits from the carbon 52, the glass mat 15, or a combination of both.

In sum, the present disclosure may be related to treatment of the laminate component of a flooded or enhanced flooded battery separator or AGM battery separator, and/or methods of treatment and manufacturing thereof for use in high charge acceptance applications of flooded or EFB batteries and AGM batteries. For enhancement of high charge acceptance capability of the negative electrode, the laminate may be coated with a mixture of high surface area carbon 52, lignosulfonate 54 and a binder 56. The coated laminate 15 may be air dried and used as a scrim for the negative electrode. This dried coated glass mat or scrim 15 may be placed either on a negative separator leaf or envelope such that it faces the surface of the negative electrode in a cell assembly. The carbon additive may have a specific surface area in the range of 15-1500 m2/g. As an example, the lignosulfonate may be Vanisperse A, provided by Borregaard Lignotech of Sarpsborg, Norway, which is widely used as an expander for the negative electrode active material in flooded, EFB and VRLA batteries.

### Examples

Examples of the present disclosure may be directed to slurry 50 for the coating of the glass fiber mat 15 using solvent 58, preferably deionized water, high surface area carbon 52, lignosulfonate 54 and binder 56. Any solvent, other than deionized water may also be used for mixing carbon, lignosulfonate and binder. The incorporation of high surface area carbon 52, lignosulfonate 54 and the binder 56 is not limited to the process of coating of glass mat. For example, the incorporation of high surface area carbon 52, lignosulfonate 54 and binder 56 may be incorporated through extrusion or other possible application methods such as spray application. Each component and its intended benefit and/or effect is described in this section.

### Lignosulfonate 54 (Vanisperse A)

Examples of Lignosulfonate 54 may be hydrophilic and water soluble, compared to hydrophobic carbon additives. Lignosulfonates 54 may aid in the mixing and preparation of an aqueous slurry. Not only do they physically assist, lignosulfonates 54 with strong antiflocculent properties also help prevent the formation of large PbSO4 crystals during discharge state. Large PbSO4 crystals are difficult to breakdown and do not accept charge efficiently. This prevents effective recharge and consequent conversion of PbSO4 into Pb. In the recharge state, the same lignosulfonates 54 may preserve the spongy lead structure on a negative electrode. Lignosulfonates 54 may also prevent the passivation of the negative electrode through deposition of large PbSO4 crystals. Lignosulfonates 54 may facilitate the conversion of inert orthorhombic PbO to tetragonal PbO at the surface of the negative electrode, thereby increasing the electrochemical activity of the electrode.

Studies have shown that although high surface area carbons 52 alone may enhance the charge acceptance capability of lead acid battery 10, they inhibit the effect of lignosulfonates 54 and consequently reduce the cold cranking capacity of the battery. The instant disclosure recognizes that the above problem may be mitigated by using excess lignosulfonate 54 compared to carbon 52 in slurry 50. Lignosulfonates 54 other than Vanisperse A may be used in the slurry.

### High Surface Area Carbon 52

Examples of high surface area carbon 52 useable in slurry 50 may have specific surface area in the range of 15-1800 m2/g. In select embodiments, the possibly preferred range for the carbon specific surface area may be in the range of 1300-1500 m2/g, which may be known as PBX51 supplied by Cabot Corporation of Boston, Mass. carbon 52 may constitute 10%-40% of the final dry coating by weight. The possibly preferred range for PBX51 may be 30%-40% by dry weight of the coating mix or slurry 50. Carbon 52 in slurry 50 may also be Timrex C-Sperse 2053 or Timrex CyPbrid supplied by Imerys Graphite and Carbons of Bironico, Switzerland. Loading of carbon 52 may again be in the range of 10%-40% of solids in slurry 50.

Carbons 52 with high surface area have been known to significantly increase charge acceptance and cycle life in high power applications such as micro hybrid vehicles, mild hybrid vehicles, Energy Storage Systems and E-bikes. Carbon 52 may have a capacitive effect due to its large surface area in close proximity to the current collector grid and/or negative active material. Also, carbon 52 may poses a steric hindrance in growth of large lead sulfate crystals and ensures the efficient recharge of lead sulfate back into lead. This prevents sulfation of the negative electrodes and increases the life of battery 10 (for support, see P. Bača, K. Micka, P. Křivik, K. Tonar, P. Tošer, Study of the influence of carbon on the negative lead-acid battery electrodes, J. Power Sources 196 (2011) 3988-3992; and K. Micka, M. Calábek, P. Baja, P. Křivik, R. Labus, R. Bilko, Studies of doped negative valve-regulated lead-acid battery electrodes, J. Power Sources 191 (2009) 154-158).

Flooded batteries in deep discharge cycling application fail often due to acid stratification issues, when the denser sulfuric acid produced during charging settles to the lower part of the cell. Some battery designs with an adjacent carbon sheet in contact with the negative electrode surface have been known to restrict the stratification process by producing smaller acid droplets when the acid passes through the pores of the carbon coated sheet and/or carbon sheet (for support, see J. Furukawa, K. Smith, L. T. Lam, D. A. J. Rand, Towards sustainable road transport with the UltraBattery™, in J. Garche, E. Karden, P. T. Moseley, D. A. J. Rand (Eds.); and Lead-Acid Batteries for Future Automobiles, Elsevier, Amsterdam, The Netherlands, 2017, pp. 349-391. ISBN: 978-0-444-63700-0). High surface area carbons 52 may help in electrode irrigation by providing acid reservoir when used in NAM (for support, see P. T. Moseley, D. A. J. Rand et al., Understanding the functions of supplementary carbon and its management in the negative active-mass of lead-acid battery: A review of progress, J. Energy Storage 19(2018) 272-290). Even when used in close contact with the surface of the negative electrode, carbon 52 may have a beneficial effect as an acid reservoir.

Carbons 52 may be other carbons that may play an active role in increasing charge acceptance such as graphite, activated carbon, acetylene black, graphene, discrete carbon nanotubes, which might be used instead of high surface area carbon 52. The carbon component may be a blend of high surface area carbon 52 and conductive carbon black. The carbon black may help in increasing the conductance of the coated mat or scrim 15 and high surface area carbon 52 may help in increasing the capacitive effect.

### Binder/Mixing Aid 56

Examples of the binder/mixing aid 56 may be MA80 from Colonial Chemical of South Pittsburgh, Tenn., which may be used as a wetting agent in the SLI and EFB flooded battery separators. MA80, a surfactant, may help reduce the surface energy of slurry 50 and aid in the effective mixing and preparing of a homogeneous slurry 50 for coating of glass mat scrim 15. A binder and/or mixing aid other than MA80 may be used in slurry 50. Other useful binders may be CMC (carboxymethylcellulose), fumed silica, Gum Arabic, Guar Gum, PVA (Polyvinylalcohol), PEG 300 (polyethylene glycol), PVDF (polyvinylidene fluoride) and liquid Teflon.

### Glass Laminate/AGM Pasting Paper/AGM Thin Separator

Examples of the laminate structure for use with an AGM separator or an EFB or flooded battery separator may consist of glass microfibers, or synthetic fibers or a composite of glass and synthetic fibers. The laminate may be an Evalith B10, B15 or B20 glass mat from Johns Manville or an Owens Corning B3A or B4A glass mat. The laminate may also be a glass microfiber scrim, pasting paper of separator made with a blend of chopped glass strands, coarse glass microfibers, fine glass microfibers and synthetic fibers and binder. The coarse glass microfiber diameter may range from 0.8 μm to 2.8 μm. The fine glass microfiber diameter may range from 0.1 μm to 1.5 μm. Synthetic fibers may include PET (polyethylene terephthalate), PBT (polybutylene terephthalate), PAN (polyacrylonitrile) fibers. The laminate binder may be an aqueous acrylate such as Aquaset or the like. The BET surface area of such a glass microfiber scrim or pasting paper may be 0.4-2.2 m2/g when measured with Micromeritics Gemini 2390p or a similar surface area analyzer like TriStar as per BCIS-3A technical manual (Battery Council International Standard 3A). The maximum pore size of such an AGM thin separator or pasting paper may be in the range of 4 μm-30 μm, when measured with a capillary flow porometer and liquid porosimetry method or first bubble method as per BCIS-3A technical manual.

With the above example components, an aqueous slurry 50 was prepared using high surface area carbon 52, excess Vanisperse A 54, deionized water as solvent 58 and binder 56. A coarse or fine fiber glass mat 15 was coated with this slurry 50 and air dried at ambient temperature between 20° C.-25° C. The drying process may be other processes than air drying, included but not limited to, a convective heating tunnel or infrared heating in a temperature range of 50° C. to 100° C. A polyester scrim may also be used instead of glass mat.

In order to test the degree of charge acceptance enhancement, the coated glass mat/scrim 15 was tested in an automotive 2V cell set up. The coated glass mat/scrim 15 was placed in the negative separator envelope and tested in a 7 plate 2V cell. DuroForce ULR battery separator for EFB applications from Microporous LLC of Pine Flats, Tenn. was utilized over all screening tests. DuroForce ULR is a UHMWPE separator membrane. The C20 capacity of the cell is approximately 30 Ah. The cell was then formed and tested as per the dynamic charge acceptance test of EN 50342:6-2015. As per this test method, the cell or battery is discharge to a certain DoD (Depth of Discharge) such as 20% DoD, 40% DoD, 60% DoD and 80% DoD and then put on a charge and discharge cycle twenty times. The average charge current over 20 cycles is then calculated. As a result of using coated glass mat/scrim 15 with slurry 50 in a 2V lead acid battery cell tested under DCA conditions, the average charge current tripled compared to that of a standard cell with no carbon coated glass mat in the separator. The charge current increase is 200% from standard control cell charge current. Acid stratification mitigation benefits from carbon and/or glass mat and/or a combination of both was achieved.

In sum, by incorporating slurry 50 on to a scrim or laminate or AGM separator, the disclosure allows for a convenient application method that avoids processing inconvenience.

Several advantages of using the above slurry 50 for coating a scrim or laminate with a flooded or an enhanced flooded battery separator or an AGM battery separator are given below.
Lignosulfonate and carbon additions can be easily targeted.
Allows for more specific NAM (Negative Active Material) to lignosulfonate-carbon contact.
Allows for more electrolyte to lignosulfonate-carbon contact.
Avoids expander and carbon processing issues during NAM manufacturing.
Allows for higher paste densities in the negative electrode compared to when expander and carbon is incorporated in NAM.

In the specification and/or figures, typical embodiments of the disclosure have been disclosed. The present disclosure is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein but is limited only by the following claims.

1. A method of manufacturing a battery separator to increase charge acceptance, cycle life or a combination thereof of a lead-acid battery with a glass mat scrim on a negative separator comprising:
coating the glass mat scrim on the negative separator with a slurry including a high surface area carbon and a lignosulfonate.

2. The method of claim 1, wherein the coating of the glass mat scrim on the negative separator with the slurry is configured to increase charge acceptance, cycle life, or combinations thereof of the lead acid battery.

3. The method of claim 1, wherein the lead-acid battery is a flooded or an enhanced flooded battery (EFB) or an absorbed glass mat (AGM) battery, wherein the method of manufacturing further including:
drying the coated glass mat scrim including:
air drying the coated glass mat scrim; or
using a convective heating tunnel or infrared heating in a temperature range of 50° C. to 100° C.;
placing the glass mat scrim with the applied slurry on a negative separator leaf or an envelope such that the glass mat scrim with the applied slurry faces the surface of a negative electrode in a cell assembly.

4. The method of claim 1, wherein the slurry coated to the glass mat scrim on the negative separator including:
the high surface area carbon;
the lignosulfonate; and
a binder.

5. The method of claim 4, wherein:
the high surface area carbon has a specific surface area between 15-1800 m2/g;
the lignosulfonate is hydrophilic and water soluble compared to hydrophobic carbon additives, wherein the lignosulfonates aid in mixing and preparation of the slurry;
the binder is a mixing aid;
or
combinations thereof.

6. The method of claim 5, wherein:
the specific surface area of the high surface area carbon is between 1300-1500 m2/g;
the lignosulfonates are configured to prevent the formation of large PbSO4 crystals during discharge state with strong antiflocculent properties which prevents affective recharge and consequent conversion of PbSO4 into Pb;
the binder is a surfactant that helps reduce the surface energy of the slurry and aids in the effective mixing and preparing a homogeneous slurry for coating of the glass mat or scrim;
or
combinations thereof.

7. The method of claim 6, wherein:
the high surface area carbon is 10%-40% by dry weight of the slurry;
the lignosulfonates preserve a spongy lead structure on the negative electrode in the recharge state;
the binder is MA80, Guar Gum, Gum Arabic, Carboxymethylcellulose, fumed silica, or PEG;
or
combinations thereof.

8. The method of claim 7, wherein:
the high surface area carbon is PBX51 and is 30%-40% by dry weight of the slurry;
the lignosulfonates is Vanisperse A;
the binder is MA80;
or
combinations thereof.

9. The method of claim 3, wherein the slurry applied to the glass mat scrim on the negative separator further comprising a solvent for mixing the slurry, wherein the solvent does not include ionized water.

10. The method of claim 1, wherein:
the high surface area carbon is configured to have a capacitive effect due to its large surface are in close proximity to the current collector grid or negative active material;
the high surface area carbon poses a steric hindrance in growth of large lead sulfate crystals and ensures the efficient recharge of lead sulfate back into lead, thereby preventing sulfation of the negative electrodes and increasing the life of the lead-acid battery;
the high surface area carbon is configured to help in electrode irrigation by providing acid reservoir when used in negative active material;
the high surface area carbon is configured to have a beneficial effect as an acid reservoir, even when used in close contact with the surface of negative electrode;
charge acceptance of the lead-acid battery is increased between 2 and 3 times compared to that of a standard cell with no carbon coated glass mat in the separator of a lead acid battery 2V cell tested under DCA conditions;
the slurry applied on the glass mat or scrim provided acid stratification mitigation benefits from the carbon, the glass mat, or a combination of both;
or
combinations thereof.

11. A battery separator for a lead-acid battery with a glass mat scrim on a negative separator comprising:
a slurry coated on the glass mat scrim on the negative separator, the slurry including:
a high surface area carbon; and
a lignosulfonate.

12. The battery separator of claim 11, wherein the slurry coated on the glass mat scrim on the negative separator is configured to increase charge acceptance, cycle life, or combinations thereof of the lead acid battery.

13. The battery separator of claim 11, wherein the lead-acid battery is a flooded or an enhanced flooded battery (EFB) or an absorbed glass mat (AGM) battery, wherein the battery separator includes the glass mat scrim with the applied slurry on a negative separator leaf or an envelope such that the glass mat scrim with the applied slurry faces the surface of a negative electrode in a cell assembly.

14. The battery separator of claim 11, wherein the slurry coated to the glass mat scrim on the negative separator including:
the high surface area carbon;
the lignosulfonate; and
a binder.

15. The battery separator of claim 14, wherein:
the high surface area carbon has a specific surface area between 15-1800 m2/g;
the lignosulfonate is hydrophilic and water soluble compared to hydrophobic carbon additives, wherein the lignosulfonates aid in mixing and preparation of the slurry;
the binder is a mixing aid;
or combinations thereof.

16. The battery separator of claim 15, wherein:
the specific surface area of the high surface area carbon is between 1300-1500 m2/g;
the lignosulfonates are configured to prevent the formation of large PbSO4 crystals during discharge state with strong antiflocculent properties which prevents affective recharge and consequent conversion of PbSO4 into Pb;
the binder is a surfactant that helps reduce the surface energy of the slurry and aids in the effective mixing and preparing a homogeneous slurry for coating of the glass mat or scrim;
or
combinations thereof.

17. The battery separator of claim 16, wherein:
the high surface area carbon is 10%-40% by dry weight of the slurry;
the lignosulfonates preserve a spongy lead structure on the negative electrode in the recharge state;
the binder is MA80, Guar Gum, Gum Arabic, Carboxymethylcellulose, fumed silica, or PEG;
or
combinations thereof.

18. The battery separator of claim 17, wherein:
the high surface area carbon is PBX51 and is 30%-40% by dry weight of the slurry;
the lignosulfonates is Vanisperse A;
the binder is MA80;
or
combinations thereof.

19. The battery separator of claim 13, wherein the slurry applied to the glass mat scrim on the negative separator further comprising a solvent for mixing the slurry, wherein the solvent does not include ionized water.

20. The battery separator of claim 11, wherein:
the high surface area carbon is configured to have a capacitive effect due to its large surface are in close proximity to the current collector grid or negative active material;
the high surface area carbon poses a steric hindrance in growth of large lead sulfate crystals and ensures the efficient recharge of lead sulfate back into lead, thereby preventing sulfation of the negative electrodes and increasing the life of the lead-acid battery;
the high surface area carbon is configured to help in electrode irrigation by providing acid reservoir when used in negative active material;
the high surface area carbon is configured to have a beneficial effect as an acid reservoir, even when used in close contact with the surface of negative electrode;
charge acceptance of the lead-acid battery is increased between 2 and 3 times compared to that of a standard cell with no carbon coated glass mat in the separator of a lead acid battery 2V cell tested under DCA conditions;
the slurry applied on the glass mat or scrim provided acid stratification mitigation benefits from the carbon, the glass mat, or a combination of both;
or
combinations thereof.
